(19) United States
(12) Patent Application Publication
(10) Pub. No.: US 2009/0323980 A1
(43) Pub. Date: Dec. 31, 2009

(54) ARRAY MICROPHONE SYSTEM AND A METHOD THEREOF

(75) Inventors: Li-Te Wu, Taipei (TW); Wei-Chan Hsu, Cupertino, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 12/146,739

(22) Filed: Jun. 26, 2008

(51) Int. Cl. H04R 3/00

(52) U.S. Cl. 381/92

(57) ABSTRACT

An array microphone system of compensating phase drift of input signals and a method thereof. The microphone system comprises a speaker, first and second microphones, a delay estimator, and a memory. The speaker outputs an acoustic signal. The first and second microphones, spaced by a predetermined distance, receive the acoustic signal to generate first and second input signals. The delay estimator, coupled to the first and second microphones, computes a time difference between the first and second input signals. The memory, coupled to the delay estimator, stores the time difference.

### BACKGROUND OF THE INVENTION

1. Field of the Invention

The invention relates to an acoustic system, and in particular to an array microphone system and a method thereof.

2. Description of the Related Art

An array microphone system is used to provide directional acoustic signal, so that only the acoustic signal at the desired direction can be picked up by array microphones in the system, increasing signal to noise ratio of the retrieved acoustic signal. It is known to implement directional signals by using an array of microphone cells and time delaying and superimposing the output signals to derive a directional output signal, i.e., the direction of the output signal can be controlled by the time delay of the delay cells. The array microphones are electrical transducer devices that comprise intrinsic parasitic capacitance. Each transducer device may comprise different parasitic capacitance, the input signal received by each microphone experiences different loading and thus different time delay. Since the direction of the output signal of the array microphone system is determined by the time delay, the relative time delay arising from the parasitic capacitance also shifts the direction of the output signal, such that the direction is no longer at the designed angle, decreasing signal to noise ratio of the input signal.

Thus a need exists for an array microphone system capable of compensating the phase drift caused by the parasitic capacitance.

### BRIEF SUMMARY OF THE INVENTION

A detailed description is given in the following embodiments with reference to the accompanying drawings.

According to the invention, a method of compensating phase drift of input signals in a microphone system is disclosed, comprising a speaker outputting an acoustic signal, providing first and second microphones spaced by a predetermined distance, the first and second microphones receiving the acoustic signal to generate first and second input signals, a delay estimator computing a time difference between the first and second input signals, and a memory storing the time difference.

A microphone system capable of compensating phase drift of input signals is also provided, comprising a speaker, first and second microphones, a delay estimator, and a memory. The speaker outputs an acoustic signal. The first and second microphones, spaced by a predetermined distance, receive the acoustic signal to generate first and second input signals. The delay estimator, coupled to the first and second microphones, computes a time difference between the first and second input signals. The memory, coupled to the delay estimator, stores the time difference.

### BRIEF DESCRIPTION OF THE DRAWINGS

The invention can be more fully understood by reading the subsequent detailed description and examples with references made to the accompanying drawings, wherein:

FIG. 1a is a block diagram of a conventional array microphone system.

FIG. 1b is a block diagram of a circuit scheme in an array microphone system.

FIG. 1c show polar diagrams of a beam forming scheme, incorporating the conventional array microphone system in FIG. 1.

FIG. 1d show polar diagrams of another beam forming scheme.

FIG. 2 is a block diagram of an exemplary array microphone system according to the invention.

FIG. 3 is a block diagram of an exemplary delay circuit in the array microphone system in FIG. 2.

FIG. 4 is a block diagram of an exemplary delay estimator in the array microphone system in FIG. 2.

FIG. 5a is a block diagram of an exemplary calibration scheme for compensating parasitic capacitance in the array microphone system in FIG. 2.

FIG. 5b is a flowchart is an exemplary calibration method for compensating parasitic capacitance, incorporating the apparatus setup in FIG. 5a.

FIG. 6a is a block diagram of another exemplary calibration scheme for compensating parasitic capacitance in the array microphone system in FIG. 2.

FIG. 6b is a flowchart is another exemplary calibration method for compensating parasitic capacitance, incorporating the apparatus setup in FIG. 6a.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

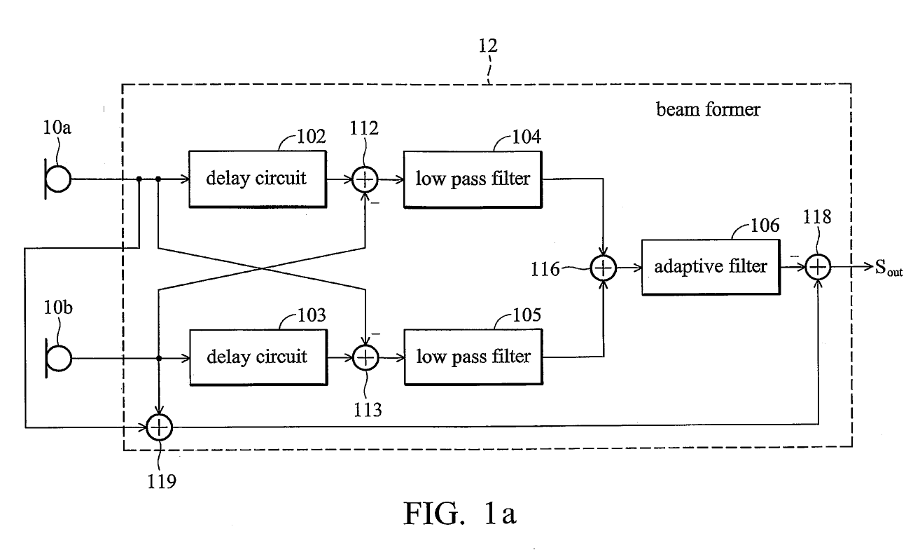

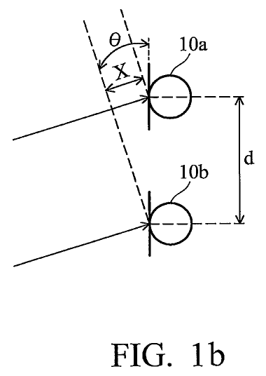

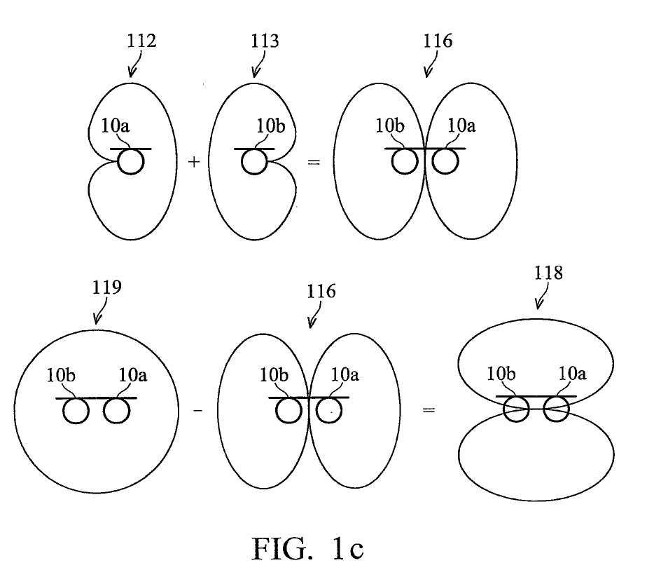

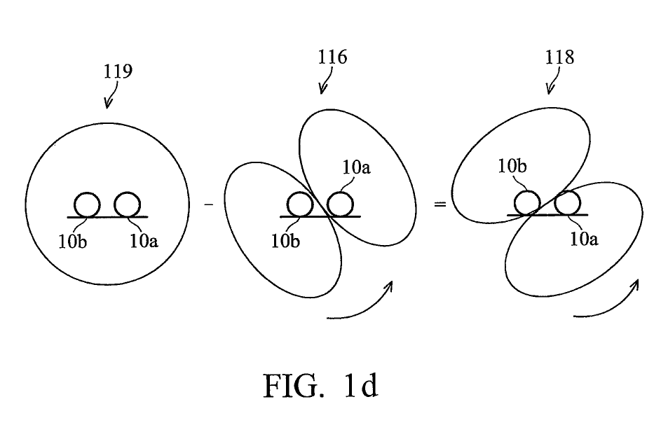

FIG. 1a is a block diagram of a conventional array microphone system, comprising array microphones 10a and 10b and a beam former 12 coupled thereto. The beam former 12 comprises delay circuits 102 and 103, subtractors 112 and 113, low pass filters 104 and 105, an adder 116, an adaptive filter 106, a subtractor 118, and an adder 119. The array microphones 10a and 10b are coupled to the adder 119 and the delay circuits 102 and 103, the subtractors 112 and 113, the low pass filters 104 and 105, the adder 116, the adaptive filter 106, and subsequently to the subtractor 118. The subtractor 118 is also coupled to the adder 119.

The microphones 10a and 10b are omni-directional microphone cells spaced by a predetermined distance d, with microphone sensitivity identical for all incident angles of captured acoustic signals. The sum of the received signals of the omni-directional microphones is also an omni-directional signal.

The microphones 10a and 10b obtains acoustic signal from the air to generate first and second input signals. The beam former 12 processes the first and second input signals to produce directional acoustic output signal Sₒᵤₜ. In the beam former 12, the first and second input signals are delayed by predetermined time t₁ and t₂ by the delay circuits 102 and 103. The delayed first input signal is superimposed with the second input signal in the subtractor 112 to form a first order cardioid characteristic. Likewise, the subtractor 114 superimposes the delayed second input signal and the first input signal generates another cardioid waveform. It could be shown that the resultant cardioid waveform is proportional to the incident angle of the acoustic signal. The predetermined delay time is selected as the quotient of distance d and sound velocity V. The adder 116 then combines two cardioids to gather after filtered out in the low pass filters 104 and 105, the output of the adder 116 is abstracted from the summation of the first and second signals, resulting in the desirable directional acoustic output signal Sₒᵤₜ.

FIG. 1b is a block diagram of a circuit scheme in an array microphone system, comprising the microphones 10a and 10b in FIG. 1a. The microphones 10a and 10b are spaced by the predetermined distance d, receiving the acoustic signal at an incident angle θ, the incident angle θ being the angle deviating from the normal line perpendicular to the connection plane of the microphones 10a and 10b. The source of the acoustic signal is assumed far from the microphones, so that the acoustic signal can be approximated as a planar wave, i.e., the wave front of the acoustic signal arriving at the microphones 10a and 10b is planar rather than spherical, and the received power at the microphones are substantially the same. Typically, a signal source originates at a distance exceeding 25 cm from the microphones can be regarded as a far source. In the embodiment illustrated in FIG. 1b, the acoustic signal travels through air to arrive the microphone 10b firstly and then to the microphone 10a at a delayed time t=X/V=d sin θ/V, where X is the additional distance that the planar wave travels through to arrive the microphone 10a, and V is the sound propagation velocity. For a mono tone acoustic signal, the microphone 10a can generate a voltage signal accordingly:

$${V}_{10 a} = A sin [ ω ( t + \frac{d sin θ}{2 V} ) ] \qquad [ 1 ]$$

Similarly, the microphone 10b can generate a second voltage signal according to the acoustic signal:

$${V}_{10 b} = A sin [ ω ( t - \frac{d sin θ}{2 V} ) ] \qquad [ 2 ]$$

By subtracting the second voltage signal from the first one, the subtracted result is:

$$\begin{matrix}Δ V = {V}_{10 a} - {V}_{10 b} \\ = A sin [ ω ( t + \frac{d sin θ}{2 V} ) ] - A sin [ ω ( t - \frac{d sin θ}{2 V} ) ] \\ = A cos ( ω t ) \cdot 2 sin ( \frac{ω d sin θ}{2 V} )\end{matrix} \qquad [ 3 ]$$

Equation 3 shows that the V is 90° delay of the incoming signal with a gain of

$$2 sin ( \frac{ω d sin θ}{2 V} ) .$$

When the incident angle is 0°, the gain is also 0. So the array microphone system in FIG. 1a can be treated as a spatial filter filtering out the sound at 0° (normal incident) and reserving sound from other angles.

FIG. 1c show polar diagrams of a beam forming scheme, incorporating the conventional array microphone system in FIG. 1a. A polar diagram indicates how sensitive the microphone is to sounds arriving at different angles about its central axis. At the subtractors 112 and 113, the delayed input signal from one microphone is added the undelayed input signal from the other microphone to derive cardioid signals comprising left and right acoustic coverage. The two cardioid signals are combined to form a bi-directional acoustic signal covering primarily the left and right sections. The adaptive filter 106 removes correlated information g between the two cardioid signals S₁₁₄ and S₁₁₅, providing the left-right bi-directional signal. In the illustrated embodiment, the normal incident signal is preferred, thus the acoustic signal from 0° and 180° are preserved and the signal from −90° (left) and 90° (right) are attenuated, implemented by taking off the bi-directional signal at the adder 116 from the omni-directional signal at the adder 119, resulting in a bi-directional acoustic signal Sₒᵤₜ covering front and back sections.

The microphones 10a and 10b are transducer devices capable of converting acoustic signals into voltage signals, comprising intrinsic parasitic capacitance that would act as a first order high pass filter and introduce phase delay to the converted voltage signals. The phase delay is a function of frequency of the acoustic signal. If the 3 db frequency of the microphones 10a and 10b are identical, the relative phase delay therebetween is zero. If the 3 db frequency of the microphones 10a and 10b are different, the relative phase delay is non-zero. The intrinsic parasitic capacitance component of the microphone also affects signal propagation delay. Since each transducer microphone device has a difference parasitic capacitance, the propagation delay of the input signals from the microphones 10a and 10b are different, resulting in a relative time delay therebetween. In an array microphone system, relative time delay is more important than relative phase delay. The relative time delay ΔT can be estimated by ΔT=Δθ/2πf. In the presence of the relative time delay ΔT, the acoustic signal picked up by microphones 10a and 10b can be expressed as:

$$\begin{matrix}{V}_{10 a} = A sin [ ω ( t + \frac{d sin θ}{2 V} + Δ T ) ] & [ 4 ] \\ {V}_{10 b} = A sin [ ω ( t - \frac{d sin θ}{2 V} ) ] & [ 5 ]\end{matrix}$$

and the signal at the node 113 is:

$$\begin{matrix}{V}_{113} = A cos ( ω t ) \cdot 2 sin ( \frac{ω d sin θ}{2 V} + \frac{Δ T ( ω )}{2} ) \\ = A cos ( ω t ) \cdot 2 sin [ \frac{ω d}{2 V} ( sin θ + Δ T ( ω ) \cdot \frac{V}{ω d} ) ]\end{matrix} \qquad [ 6 ]$$

From Equation 6, the attenuated incident angle becomes

$${sin}^{- 1} [ Δ T ( ω ) \frac{V}{ω d} ] .$$

FIG. 1d show polar diagrams of another beam forming scheme, taking the effect of the relative time delay in the conventional array microphone system into consideration. The polar pattern of the input signal difference between the input signals received by microphones 10a and 10b shifts an angle

$${sin}^{- 1} [ Δ T ( ω ) \frac{V}{ω d} ] .$$

When the shifted angle is 90°, the conventional array microphone system cannot detect the input signal at the desirable direction, thus the acoustic signal cannot be retrieved properly.

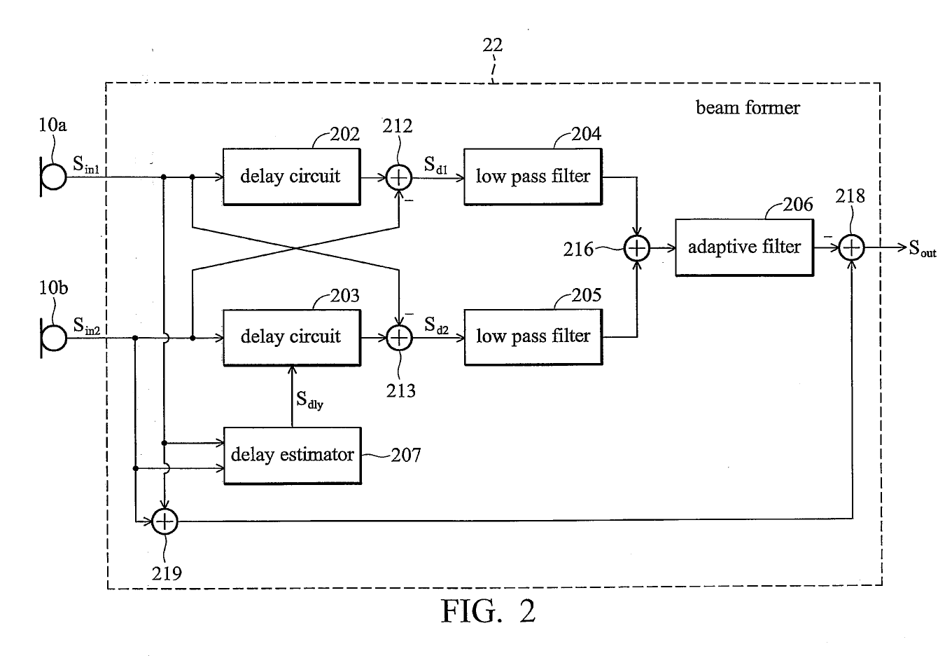

FIG. 2 is a block diagram of an exemplary array microphone system according to the invention, comprising array microphones 10a and 10b and a beam former 22 coupled thereto. The beam former 12 comprises a delay estimator 207, delay circuits 202 and 203, subtractors 212 and 213, low pass filters 204 and 205, an adder 216, an adaptive filter 206, a subtractor 218, and an adder 219. The array microphones 10a and 10b are coupled to the delay estimator 207, the adder 219, and the delay circuits 202 and 203, in turn coupled to the subtractors 212 and 213, the low pass filters 204 and 205, the adder 216, the adaptive filter 206, and subsequently to the subtractor 218. The subtractor 218 is coupled to the adder 219. The delay estimator is coupled to the delay circuit 203.

The array microphone system in FIG. 2 operates in calibration mode or normal operation mode. The microphones 10a and 10b (first and second microphones) receive acoustic signal played by a speaker (not shown), convert the acoustic signal to voltage signals, and generate first input signal Sin1 and second input signal Sin2. The acoustic signals, the first input signal Sin1 and the second input signal Sin2 comprise more than one sub-band signals occupying different spectrum. The microphones 10a and 10b are spaced apart by the predetermined distance d, as depicted in FIG. 1b. During the calibration mode, the array microphone system estimates the relative time delay (time difference) between the input signals from the microphones 10a and 10b and stores the result in internal memory (not shown). The memory may be non-volatile memory, such as EEPROM, flash, or hard disk. During the normal operation mode, the array microphone system removes the rotation of the directional lobe according to the stored the relative time delay, correcting the output signal Sₒᵤₜ to the designed direction. The delay estimator 207 estimates the relative time delay by computing a time difference between the first and second input signals at the calibration mode, and remains inactive at the normal operation mode.

The beam former 22 receives the first input signal Sin1 and second input signal Sin2 to generate the output signal Sₒᵤₜ with a predetermined spatial direction by delaying the first input signal Sin1 according to the predetermined distance d, delaying the second input signal Sin2 according to the predetermined distance d and the relative time delay, and combining the delayed first input signal and the delayed second input signal to provide the output signal Sₒᵤₜ. The principle operation of the beam former is explained in FIGS. 1a and 1c. The delay circuit 203 receives a delay control signal S_{dly} from the delay estimator 207 to decrease the relative time delay, removing the spatial rotation

$${sin}^{- 1} [ Δ T ( ω ) \frac{V}{ω d} ]$$

of the output signal Sₒᵤₜ. In the embodiment, the delay control signal S_{dly} comprises the relative time delay information, and the delay circuit 203 further delays the second input signal Sin2 by the time duration of the relative time delay to bring back the shifted angle of the output signal Sₒᵤₜ to the desired direction, increasing the signal to the noise ratio of the output signal Sₒᵤₜ.

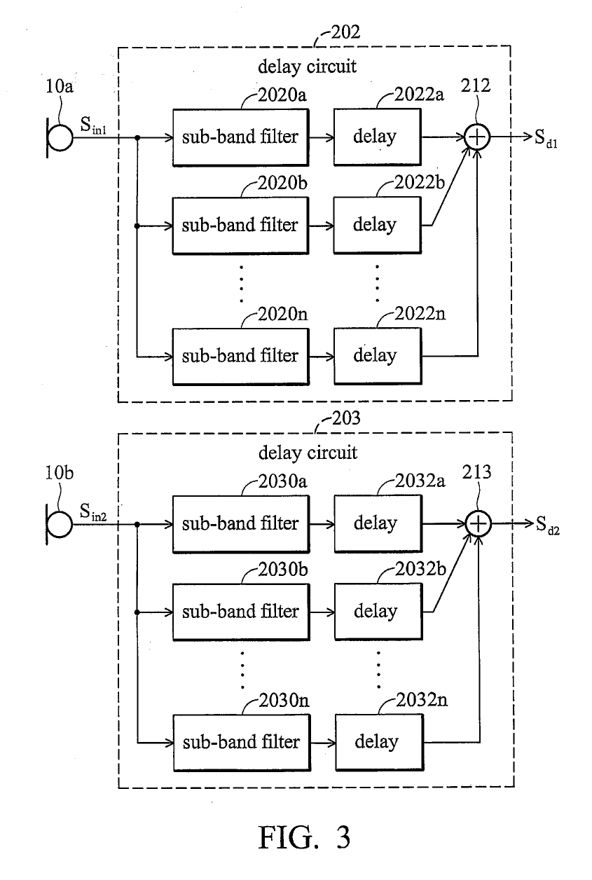

FIG. 3 is a block diagram of an exemplary delay circuit in the array microphone system in FIG. 2, where the delay circuit 202 comprises sub-band filters 2020a through 2020n, delay units 2022a through 2022n, and an adder 212 (first delay adder), the delay circuit 203 comprises sub-band filters 2030a through 2030n, delay units 2032a through 2032n, and an adder 213 (second delay adder). Each sub-band filter is coupled to a corresponding delay unit, the delay units 2022a through 2022n are coupled to the adder 212, and the delay units 2032a through 2032n are coupled to the adder 213.

Since the acoustic signals, the first input signal Sin1 and the second input signal Sin2 comprise more than one sub-band signals occupying different spectrum, sub-band filters 2020a through 2020n and 2030a through 2030n receive the first input signal Sin1 and the second input signal Sin2 to obtain a predetermined sub-band signal so that the delay units 2022a through 2022n and 2032a through 2032n can process each sub-band signal separately and delay each sub-band signal with a dedicated time delay. The first delay adder 212 sums up all delayed sub-band signals of the first input signal Sin1 (first input sub-band signals) to provide the delayed first input signal Sd1, and a second delay adder summing up all delayed sub-band signals of the second input signal Sin2 (second input sub-band signals)s to provide the delayed second input signal Sd2.

Each sub-band filter is a band pass filter. For example, the pass band of sub-band filters 2020a and 2030a is at 100 Hz˜500 Hz and the pass band of sub-band filters 2020b and 2030b is at 500 Hz˜1500 Hz. The time delays of the delay units 2022a through 2022n are fixed delays. The time delays of the delay units 2032a through 2032n are adjustable by the time delay signal S_{d1y}, to correct the phase shifted angle of the output signal Sₒᵤₜ, increasing the signal quality of the recorded acoustic signal.

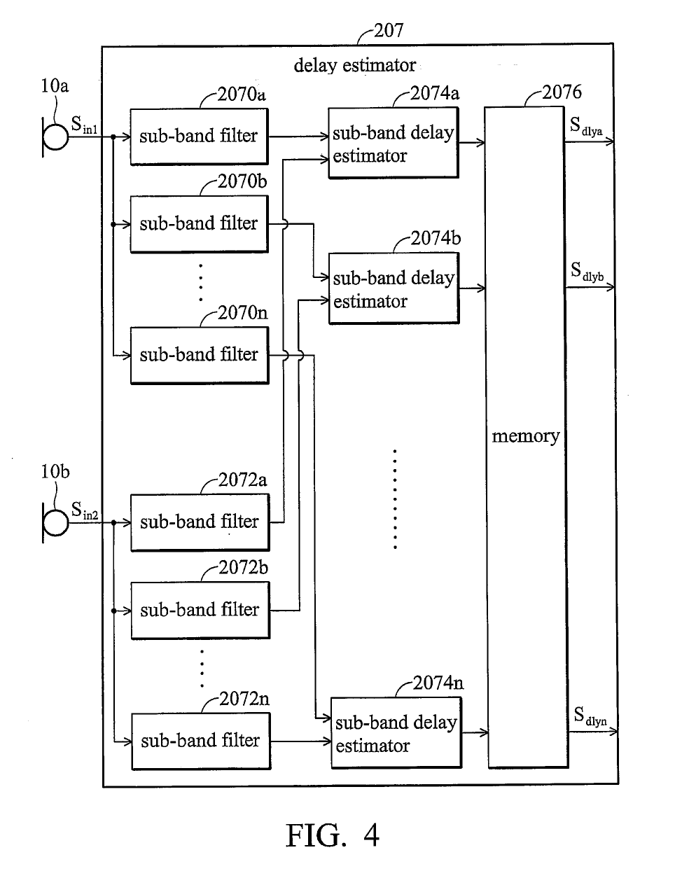

FIG. 4 is a block diagram of an exemplary delay estimator in the array microphone system in FIG. 2, comprising sub-band filters 2070a through 2070n, 2072a through 2072n, sub-band delay estimators 2074a through 2074n, and a memory 2076. Each sub-band delay estimator is coupled to two sub-band filters to estimate time difference between the output signals of the sub-band filters. For example, the sub-band filters 2070a and 2072a are coupled to sub-band delay estimator 2074a 2070a and 2072a, the sub-band filters 2070b and 2072b are coupled to sub-band delay estimator 2074b, and the sub-band filters 2070n and 2072n are coupled to sub-band delay estimator 2074n.

The relative time delay can be estimated by calculating the covariance function R(τ), where R(τ) may be expressed by:

$$R ( τ ) = {\sum }_{n = 0}^{∞} X ( n ) Y ( n + τ ) ≅ {\sum }_{n = 100}^{32768} X ( n ) \cdot Y ( n + τ ) , X ( n )$$

is the incoming data sample of the first input for the sub-band phase delay estimators 2074a through 2074n and Y(n) is the second input of sub-band phase delay estimators 2074a through 2074n. The sub-band phase delay estimator will then compare the calculated result between [R(−15), R(−14), . . . , R(−1), R(0), R(1), . . . , R(14), R(15)]. The relative time delay is the maximum value of the covariance array is R(η).

Each sub-band delay estimator comprises a cross-correlator computing the relative time delay (time difference) of the two input signals. The sub-band delay estimators 2074a through 2074n estimate the relative time delay by finding out a time delay of one input signal that resulting in the maximal cross correlation between the two input signals. The cross-correlator computes the relative time delay by firstly computing a first cross correlation between the two input signals (the first and second input signals), delaying one input signal (the second input signal) for a time duration, computing a second cross correlation between the first input signal and the delayed second input signal, and recording the time duration as the time difference when the second cross correlation exceeds the first one.

Since the acoustic signals, the first input signal Sin1 and the second input signal Sin2 comprise more than one sub-band signals occupying different spectrum, the sub-band filters 2070a through 2070n and 2072a through 2072n receive the first input signal Sin1 and the second input signal Sin2 to obtain a predetermined sub-band signal, so that the sub-band delay estimators 2074a through 2074n can estimate the relative time delay for each sub-band. The estimated relative time delays for each sub-band are stored in the memory 2076 during the calibration mode, the delay circuits 202 and 203 can access the relative time delays for each sub-band from the memory 2076 and compensate for it in the normal operation mode. The memory 2076 may be non-volatile memory, such as EEPROM, flash, or hard disk. The sub-band filters 2070a through 2070n and 2072a through 2072n and the sub-band delay estimators 2074a through 2074n are only active during the calibration mode.

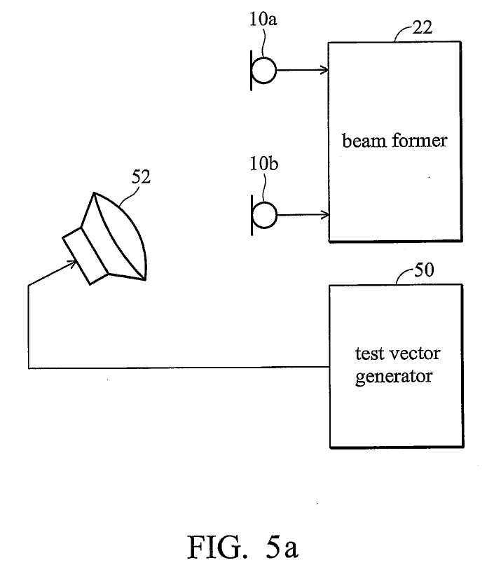

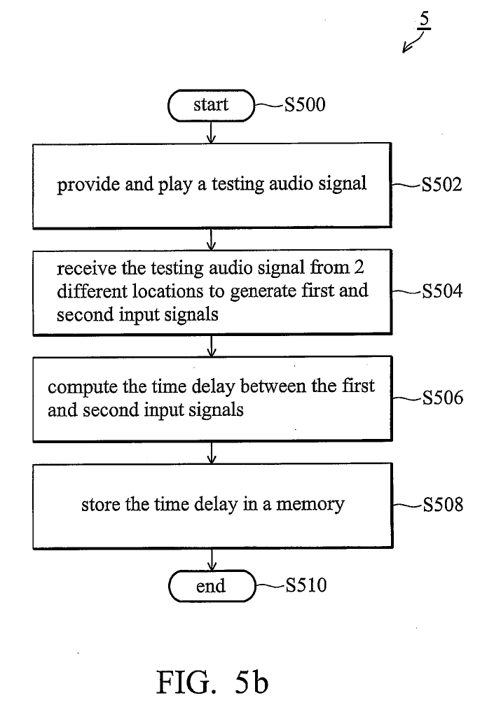

FIG. 5a is a block diagram of an exemplary calibration scheme for compensating parasitic capacitance in the array microphone system in FIG. 2, comprising a test vector generator 50, a speaker 52, microphones 10a and 10b, and beam former 22. The test vector generator 50 is coupled the speaker 52. The microphones 10a and 10b are coupled to the beam former 22.

The array microphone system may operate in the calibration mode or the normal operation mode. The distance between the microphones 10a and 10b, the microphone 10a and the speaker 52, and the microphone 10b and the speaker 52 are fixed. The speaker 52 may or may not be placed at the normal incident angle (incident angle=0°). FIG. 5b is a flowchart is an exemplary calibration method for compensating parasitic capacitance, incorporating the apparatus setup in FIG. 5a. In step S502, the test vector generator 50 generates the acoustic test signal comprising white noise to be played by the speaker 52. Next in step S504, the microphones 10a and 10b capture the acoustic test signal through the air to generate the first and second input signals, and the beam former 22 receives the first input signal Sin1 and the second input signal Sin2 to calculate the relative phase delay therebetween (S506) and store which in the memory (S508).

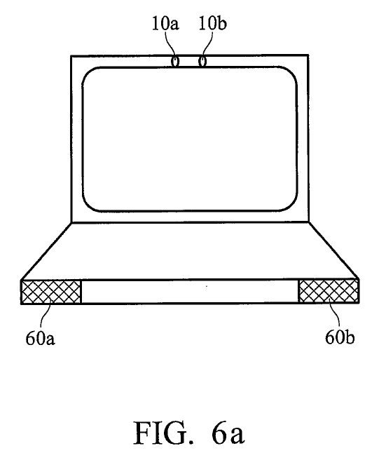

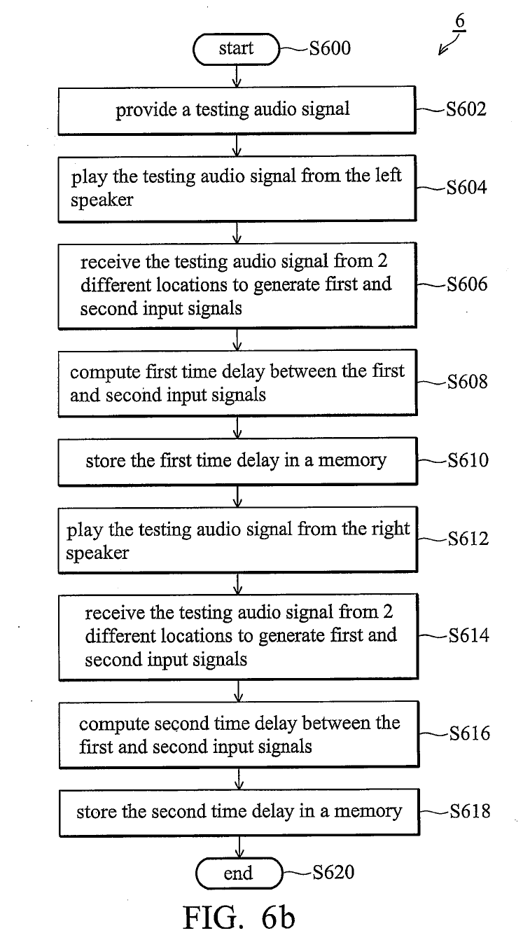

FIG. 6a is a block diagram of another exemplary calibration scheme for compensating parasitic capacitance in the array microphone system in FIG. 2, incorporated in a laptop computer. The laptop computer comprises an LCD lid that may be opened or closed, left speaker 60a, right speaker 60b, first microphone 10a, and second microphone 10b.

The test vector generator (not shown) and the beam former (not shown) are implemented in the CPU of the laptop computer using a software program. The microphones 10a and 10b are implemented on the top of the LCD edge, and the left and right speakers are located on the edge of the keyboards. The relative location between the microphones 10a and 10b is fixed. The relative location between the array microphones 10a and 10b and the left and right speakers, however, is not fixed. When Laptop LCD lid is closed, the incident angle is −90° from the microphone 10a, and 90° from the microphone 10b. When Laptop LCD cover is open, the incident angle −30° from the microphone 10a, and 30° from the microphone 10b.

FIG. 6b is a flowchart is another exemplary calibration method for compensating parasitic capacitance, incorporating the apparatus setup in FIG. 6a.

In step S602, the test vector generator provides a testing acoustic signal comprising white noise, the left speaker 60a outputs the white noise signal at step S604, the microphones 10a and 10b receive the testing acoustic signal to generate the first input signal Sin1 and the second input signal Sin2 at step S606, the beam former (not shown) calculates first relative time delay T_{L} for the testing acoustic signal originated from the left speaker 60a (S608), and stores the first relative time delay T_{L} in the memory (not shown) at step S610. Similarly, the right speaker 60b outputs the white noise signal at step S612, the microphones 10a and 10b receive the testing acoustic signal to generate the first input signal Sin1 and the second input signal Sin2 at step S614, the beam former calculates and stores second relative time delay T_{R} for the testing acoustic signal originated from the right speaker 60b (S616), and stores the second relative time delay T_{R} in the memory at step s618. The array microphone delay can be estimated by averaging the first and second relative time delay T_{L} and T_{R} to obtain an averaged relative time delay T_{AVG} by (T_{L}+T_{R})/2. The averaged relative time delay T_{AVG} may be stored in the memory for compensating the phase drift of the input signals during the normal operation mode, correcting the shifted phase angle of the output signal Sₒᵤₜ.

For example, for the beam former with 4 sub-band filters the relative time delay may be tabulated by table 1, and the averaged relative time delay T_{AVG} is provided in table 2. The averaged relative time delay T_{AVG} computed during the calibration mode may be stored in the memory for the later uses.

TABLE 1
Relative time delay between the input signals received by microphones
10a and 10b (μsec)

| | | |
|---|---|---|
| Speaker | LCD | Sub-band |

| source | cover | 1 | 2 | 3 | 4 |
|---|---|---|---|---|---|
| Left | Open | 8 | −5 | −8 | −10 |
| Right | Open | 28 | 15 | 12 | 10 |
| Left | Close | −12 | −25 | −28 | −30 |
| Right | Close | 48 | 35 | 32 | 30 |

TABLE 2
Averaged relative time delay between the input signals received by
microphones 10a and 10b (μsec)

Sub-band

| LCD cover | 1 | 2 | 3 | 4 |
|---|---|---|---|---|
| Open | 18 | 5 | 2 | 0 |
| Close | 18 | 5 | 2 | 0 |

The estimated relative time delay can be compensated by the delay control signal S_{d1y} to control the delay circuits 202 and 203 to correct the phase shifted angle of the output signal Sₒᵤₜ, increasing the signal quality of the recorded acoustic signal.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of compensating phase drift of input signals in a microphone system, comprising:
a speaker outputting an acoustic signal;
providing first and second microphones spaced by a predetermined distance;
the first and second microphones receiving the acoustic signal to generate first and second input signals;
a delay estimator computing a time difference between the first and second input signals; and
a memory storing the time difference.

2. The method of claim 1, further comprising:
a beam former delaying the first input signal according to the predetermined distance;
the beam former delaying the second input signal according to the predetermined distance and the time difference; and
the beam former combining the delayed first input signal and the delayed second input signal to provide an output signal.

3. The method of claim 2, wherein the delaying step of the second input signal comprises the beam former delaying the second input signal for a time duration of the time difference.

4. The method of claim 1, wherein the computation of the time difference comprises:
a cross-correlator computing a first cross correlation between the first and second input signals;
delaying the second input signal for a time duration, such that when the cross-correlator computing a second cross correlation between the first input signal and the delayed second input signal, the second cross correlation exceeds the first one; and
recording the time duration as the time difference when the second cross correlation exceeds the first one.

5. The method of claim 4, wherein the acoustic signals, the first and second input signals comprise more than one sub-band signals, the cross-correlator computes the cross correlation for each pair of the sub-band signals occupying identical spectrum, and the memory storing the time difference for each pair of the sub-band signals.

6. The method of claim 2, wherein the acoustic signals, the first and second input signals comprise more than one sub-band signals, and the beam former delaying step comprises each sub-band filter receiving the first or the second input signal to provide first or second input sub-band signal, a delay unit delaying each first or second sub-band signal, a first delay adder summing up all delayed first input sub-band signals to provide the delayed first input signal, and a second delay adder summing up all delayed second input sub-band signals to provide the delayed second input signal.

7. The method of claim 1, wherein the speaker comprises left and right speakers, left and right speakers and the first and second microphone are located on a laptop computer, and the output step comprises only the left speaker outputting the acoustic signal or only the right speaker outputting the acoustic signal, and the computation of the time difference comprises computing first and second time differences for the left and right speakers, and averaging the first and second time difference to provide averaged time difference to be stored in the memory.

8. A microphone system, compensating phase drift of input signals, comprising:
a speaker outputting an acoustic signal;
first and second microphones spaced by a predetermined distance, receiving the acoustic signal to generate first and second input signals;
a delay estimator, coupled to the first and second microphones, computing a time difference between the first and second input signals; and
a memory, coupled to the delay estimator, storing the time difference.

9. The microphone system of claim 8, further comprising a beam former, coupled to the first and second microphones and the memory, delaying the first input signal according to the predetermined distance, delaying the second input signal according to the predetermined distance and the time difference, and combining the delayed first input signal and the delayed second input signal to provide an output signal.

10. The microphone system of claim 9, wherein the beam former delaying the second input signal for a time duration of the time difference.

11. The microphone system of claim 8, wherein the delay estimator comprises a cross-correlator, coupled to the first and second microphones, computing a first cross correlation between the first and second input signals, delaying the second input signal for a time duration, computing a second cross correlation between the first input signal and the delayed second input signal, and recording the time duration as the time difference when the second cross correlation exceeds the first one.

12. The microphone system of claim 11, wherein the acoustic signals, the first and second input signals comprise more than one sub-band signals, the cross-correlator computes the cross correlation for each pair of the sub-band signals occupying identical spectrum, and the memory storing the a time difference for each pair of the sub-band signals.

13. The microphone system of claim 9, wherein the acoustic signals, the first and second input signals comprise more than one sub-band signals, and the beam former comprises more than one sub-band filters, a delay unit corresponding to each sub-band filter, first and second delay adders, each sub-band filter receives the first or the second input signal to provide first or second input sub-band signals, each delay unit delaying corresponding first or second sub-band signal, the first delay adder sums up all delayed first input sub-band signals to provide the delayed first input signal, and the second delay adder sums up all delayed second input sub-band signals to provide the delayed second input signal.

14. The microphone system of claim 8, wherein the speaker comprises left and right speakers, left and right speakers and the first and second microphone are located on a laptop computer, and only one of the left and right speakers outputs the acoustic signal, and the delay estimator computes the time difference first and second time differences for the left and right speakers, and averages the first and second time difference to provide averaged time difference to be stored in the memory.

15. The microphone system of claim 8, wherein the acoustic signals comprises white noise.
